(19) United States
(12) Patent Application Publication
(10) Pub. No.: US 2010/0199512 A1
(43) Pub. Date: Aug. 12, 2010

(54) CLOTHES DRYING DEVICE, AND HEAT PUMP UNIT

(75) Inventors: Kazuyoshi Tomochika, Gunma (JP); Norioki Fujimoto, Gunma (JP); Hirotaka Kakinuma, Gunma (JP)

Correspondence Address: RABIN & Berdo, PC, 1101 14TH STREET, NW, SUITE 500, WASHINGTON, DC, 20005, US

(73) Assignee: SANYO ELECTRIC CO., LTD., OSAKA (JP)

(21) Appl. No.: 12/733,510

(22) PCT Filed: Sep. 18, 2008
(86) PCT No.: PCT/JP2008/066854

§ 371 Date: Mar. 4, 2010

(30) Foreign Application Priority Data
Sep. 20, 2007 (JP) 2007-244263

(51) Int. Cl. F26B 21/08; D06F 58/04; F25B 27/00

(52) U.S. Cl. 34/73; 34/130; 62/238.7

(57) ABSTRACT

The present invention provides a garment dryer including a heat pump device. The inventive garment dryer has an improved heat exchange efficiency without uneven airflow around a heat exchanger (a heat absorber and a radiator) of the heat pump device. A heat exchange air duct portion (22) is defined in a heat pump unit (14). A heat absorber (23) and a radiator (24) are provided as a heat exchanger in the heat exchange air duct portion (22). An upstream buffer space (33) for changing the flow direction of air to regulate the flow rate of the air is provided upstream of the heat absorber (23). A downstream buffer space (34) for regulating the flow rate of the air is provided downstream of the radiator (24). As a result, the airflow around the heat exchanger is uniformly regulated, thereby improving the heat exchange efficiency of the heat exchanger.

### TECHNICAL FIELD

The present invention relates to a dryer for drying garments, particularly to a garment dryer usable for a washing/drying machine. The invention further relates to a heat pump unit for use in the dryer.

### BACKGROUND ART

A device for heating air for drying garments and a dehumidifier for dehumidifying wet air resulting from heat exchange between hot air and garments are provided in an electric washing machine, a washing/drying machine, a garment dryer and the like. Conventionally, the air heating device is generally configured to generate hot air by means of an electric heater or the like, and the dehumidifier is generally configured to dehumidify wet air by means of cooling water. It has been recently proposed to employ a heat pump device having a higher energy efficiency for the heating of the air and the dehumidification of the wet air resulting from the heat exchange with the hot air.

In general, the heat pump device includes a compressor which compresses a coolant, a radiator which releases heat of the compressed coolant, an expansion valve for reducing the pressure of the coolant compressed to a higher pressure, a heat absorber in which the coolant having a reduced pressure removes heat from the ambient atmosphere, and a pipe which connects the compressor, the radiator, the expansion valve and the heat absorber for circulation of the coolant. Where the heat pump device, which has a greater number of components, is incorporated in a washing/drying machine, for example, a special arrangement should be designed in consideration of an available space in a housing of the washing/drying machine.

Prior art solutions to this problem are proposed in Patent Document 1, Patent Document 2 and Patent Document 3.

A garment dryer described in Patent Document 1 is configured such that a heat absorber and a radiator of a heat pump device are disposed parallel to each other, and inclined in the same direction as a rear surface of a drum.

A garment dryer described in Patent Document 2 is configured such that a heat absorber and a radiator of a heat pump device are disposed parallel to each other, and the heat absorber is located at a higher position than the radiator.

A garment dryer described in Patent Document 3 is configured such that a heat absorber and a radiator of a heat pump device are disposed in a generally V-shaped configuration as seen from a lateral side to cause air to flow down around the heat absorber and flow up around the radiator, and an air passage is provided above the radiator for horizontal airflow.

### Patent Document 1: JP-A-2005-304985

### Patent Document 2: JP-A-2005-304987

### Patent Document 3: JP-A-2007-386

### DISCLOSURE OF THE INVENTION

### Problems to be Solved by the Invention

The inventors of the present invention checked the airflow around a heat exchanger (the heat absorber and the radiator) in each of the heat pump devices described in Patent Documents 1 to 3. As a result, the inventors found that the air unevenly flows around the heat absorber and/or the radiator, i.e., uneven airflow occurs, in each of the heat pump devices.

In general, the heat exchange efficiency is improved for reduction of a drying period by causing the air to uniformly flow around the heat exchanger (the heat absorber and the radiator) in the heat pump devices. The heat pump devices proposed in Patent Documents 1 to 3 suffer from the uneven airflow, each failing to exhibit a sufficient heat exchange capability. Therefore, the heat exchange capability and the drying efficiency are disadvantageously poor.

In order to solve the aforementioned problem, it is a principal object of the present invention to provide a garment dryer which includes a heat pump device and has a heat exchange capability improved by causing air to uniformly flow around a heat exchanger (a heat absorber and a radiator).

It is another object of the present invention to provide a garment dryer which includes a heat pump device properly accommodated in a housing thereof, and ensures uniform airflow around a heat exchanger thereof for circulation.

It is further another object of the present invention to provide a heat pump unit which can be incorporated in a garment dryer, and is compact in structure and excellent in heat exchange efficiency.

### Means for Solving the Problems

According to one aspect of the present invention, there is provided a garment dryer, which includes: a treatment tub in which a garment to be dried is retained; an air circulation duct having opposite ends connected to the treatment tub for causing air to flow out of the treatment tub through one of the opposite ends and flow back into the treatment tub through the other end; air blowing means for circulating the air through the air circulation duct; and a heat pump device including a heat absorber, a compressor, a radiator and pressure reducing means which are connected by a coolant pipe through which a coolant flows, the heat absorber being adapted to cool the air flowing through the air circulation duct to dehumidify the air, the radiator being adapted to heat the dehumidified air; wherein the heat absorber and the radiator each have an airflow plane for heat exchange with the air, and the airflow plane of the heat absorber and the airflow plane of the radiator are disposed in this order with respect to an airflow direction in opposed relation in the air circulation duct; wherein the air circulation duct includes an upstream buffer space provided upstream of the airflow plane of the heat absorber with respect to the airflow direction for changing the flow direction of the air to regulate the flow rate of the air.

In the garment dryer according to this inventive aspect, the air circulation duct includes a downstream buffer space provided downstream of the airflow plane of the radiator with respect to the airflow direction for uniformly regulating the flow rate of the air.

In the garment dryer according to this inventive aspect, the air blowing means is disposed downstream of the downstream buffer space with respect to the airflow direction.

According to another aspect of the present invention, there is provided a garment dryer, which includes: a treatment tub in which a garment to be dried is retained; an air circulation duct having opposite ends connected to the treatment tub for causing air to flow out of the treatment tub through one of the opposite ends and flow back into the treatment tub through the other end; air blowing means for circulating the air through the air circulation duct; and a heat pump device including a heat absorber, a compressor, a radiator and pressure reducing means which are connected by a coolant pipe through which a coolant flows, the heat absorber being adapted to cool the air flowing through the air circulation duct to dehumidify the air, the radiator being adapted to heat the dehumidified air; wherein the air circulation duct includes a heat exchange air duct portion in which the heat absorber and the radiator are incorporated; wherein the heat exchange air duct portion has an airflow direction extending generally horizontally; wherein the heat absorber and the radiator each have an airflow plane disposed in the heat exchange air duct portion as inclined with respect to the airflow direction as seen in plan.

In the garment dryer according to this inventive aspect, the heat exchange air duct portion includes an upstream buffer space provided upstream of the heat absorber.

In the garment dryer according to this inventive aspect, the heat exchange air duct portion includes a downstream buffer space provided downstream of the radiator for uniformly regulating the flow rate of the air.

In the garment dryer according to this inventive aspect, the air blowing means is provided horizontally downstream of the downstream buffer space

In the garment dryer according to this inventive aspect, the air circulation duct includes an air duct portion through which the air flows into the upstream buffer space from a horizontal upper portion of the upstream buffer space.

According to further another aspect of the present invention, there is provided a heat pump unit for the garment dryer, the heat exchange air duct portion being unitized by a casing having a generally rectangular box shape, the heat pump unit including: a heat exchange air duct defined in the casing and having an airflow direction extending generally horizontally; and a compressor and pressure reducing means provided outside the heat exchange air duct.

### EFFECTS OF THE INVENTION

According to the present invention, the upstream buffer space is provided upstream of the heat absorber, so that the direction and the flow rate of the air flowing to the heat exchanger (the heat absorber and the radiator) can be regulated. As a result, the air uniformly flows to the heat exchanger, thereby improving the heat exchange efficiency.

Further, the heat absorber and the radiator are disposed in this order with respect to the airflow direction in opposed relation. Therefore, the installation space of the heat absorber and the radiator is reduced, so that the heat pump device has a compact structure. This makes it possible to properly incorporate the heat pump device in the garment dryer.

According to the present invention, the downstream buffer space is provided downstream of the heat absorber and the radiator, i.e., downstream of the heat exchanger, so that the air evenly and uniformly flows around the heat exchanger (the heat absorber and the radiator). This improves the heat exchange efficiency.

According to the present invention, the air blowing means is disposed downstream of the downstream buffer space. Therefore, the air is sucked by the air blowing means to cause the air to flow around the heat exchanger (the heat absorber and the radiator). The airflow around the heat exchanger can be made more uniform by sucking the air having passed around the heat exchanger than by feeding air to the heat exchanger. This improves the heat exchange efficiency.

According to the present invention, the airflow direction extends generally horizontally in the heat exchange air duct portion in which the heat exchanger (the heat absorber and the radiator) is provided. Therefore, the heat exchange air duct portion can be located in a housing of the garment dryer, for example, along a bottom surface, a rear surface, a side surface or a front surface of the housing.

Further, the airflow planes of the heat absorber and the radiator are inclined with respect to the airflow direction as seen in plane in the heat exchange air duct portion and, therefore, each have a larger area. This improves the heat exchange efficiency.

According to the present invention, the direction and the flow rate of the air flowing to the heat exchanger (the heat absorber and the radiator) are regulated by the upstream buffer space, so that the air can uniformly flow around the heat exchanger.

According to the present invention, the airflow around the heat exchanger (the heat absorber and the radiator) is regulated uniformly by the downstream buffer space. This improves the heat exchange efficiency.

According to the present invention, the air is sucked by the air blowing means provided downstream of the heat exchanger (the heat absorber and the radiator) to cause the air to flow around the heat exchanger. Therefore, the airflow around the heat exchanger can be regulated more uniformly.

According to the present invention, the heat exchange air duct portion can be disposed on the bottom of the housing of the garment dryer. Therefore, the heat pump device can be properly incorporated in an empty space on the bottom.

According to the present invention, the compressor and the pressure reducing means are combined with the heat exchange air duct portion into a generally rectangular box shape to be unitized into the heat pump unit. Therefore, the heat pump unit can be easily incorporated in the housing of the garment dryer.

### BRIEF DESCRIPTION OF THE DRAWINGS

FIG. 1 is a perspective view of a washing/drying machine 1 according to one embodiment of the present invention as seen from a front right upper side with a housing (outer shell) thereof removed.

FIG. 2 is a perspective view of the washing/drying machine 1 as seen from a rear left upper side.

FIG. 3 is a right side view of the washing/drying machine 1.

FIG. 4 is a left side view of the washing/drying machine 1.

FIG. 5 is a rear view of the washing/drying machine 1.

FIG. 6 is a perspective view of a heat pump unit 14 and an air blower unit 15 as seen from a front right upper side.

FIG. 7 is a perspective view of the heat pump unit 14 and the air blower unit 15 as seen from a rear right upper side.

FIG. 8 is a front view of the heat pump unit 14 and the air blower unit 15.

FIG. 9 is a rear view of the heat pump unit 14 and the air blower unit 15.

FIG. 10 is a plan view of the heat pump unit 14 and the air blower unit 15.

FIG. 11 is a bottom view of the heat pump unit 14 and the air blower unit 15.

FIG. 12 is a right side view of the heat pump unit 14 and the air blower unit 15.

FIG. 13 is a left side view of the heat pump unit 14 and the air blower unit 15.

FIG. 14 is a schematic front view of the heat pump unit 14 for explaining the flow and the distribution of the air in a heat exchange air duct portion 22.

FIG. 15 is a schematic plan view of the heat pump unit 14 for explaining the flow and the distribution of the air in the heat exchange air duct portion 22.

FIGS. 16A and 16B are diagrams of data which verify the uniformity of the flow rate of the air flowing in the heat exchange air duct portion 22 of the heat pump unit 14.

FIGS. 17A to 17D are diagrams obtained through computer-assisted analysis of the flow of the air flowing in the heat exchange air duct portion 22 of the heat pump unit 14.

FIG. 18A is a graph showing airflow distributions of air flowing to heat absorbers of heat pump units.

FIG. 18B is a graph showing airflow distributions of air flowing to radiators of the heat pump units.

FIG. 18C is a graph showing a comparison between the airflow distributions of air flowing to the radiators and the airflow distributions of air flowing to the heat absorbers of the heat pump units.

### DESCRIPTION OF REFERENCE CHARACTERS

13: DOWNWARD AIR DUCT
14: HEAT PUMP UNIT
15: AIR BLOWER UNIT
20: CASING
21: SUB-CASING
22: HEAT EXCHANGE AIR DUCT PORTION
23: HEAT ABSORBER
24: RADIATOR
25: COMPRESSOR
26: EXPANSION VALVE (PRESSURE REDUCING MEANS)
27: COOLANT PIPE
33: UPSTREAM BUFFER SPACE
34: DOWNSTREAM BUFFER SPACE
35: TURBO FAN
36: FAN CASE
37: FAN MOTOR

### BEST MODE FOR CARRYING OUT THE INVENTION

A specific embodiment of the present invention will hereinafter be described with reference to the drawings.

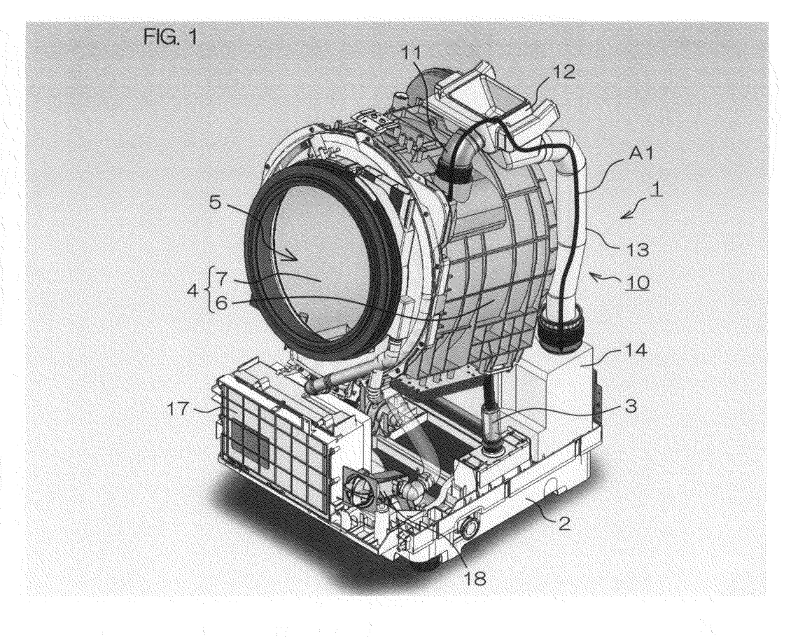

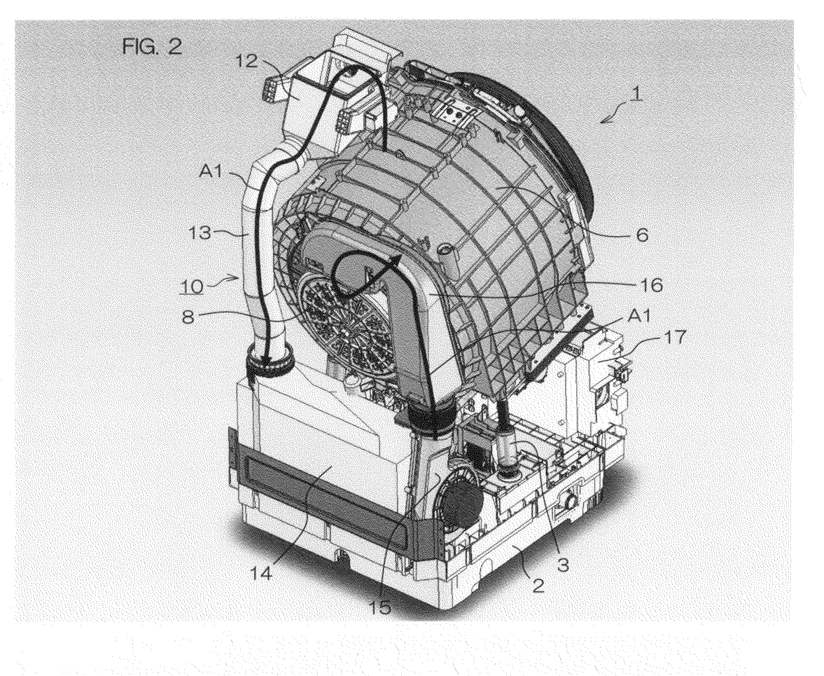

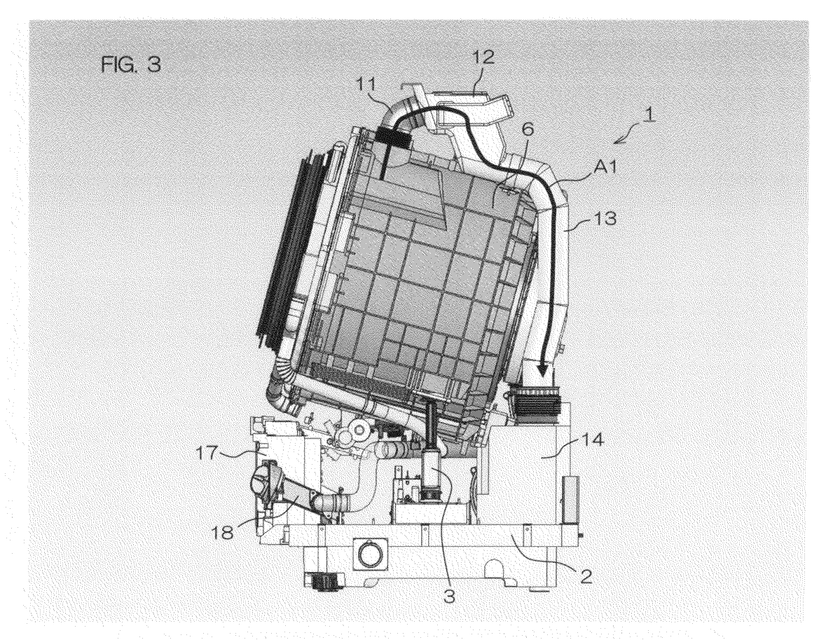

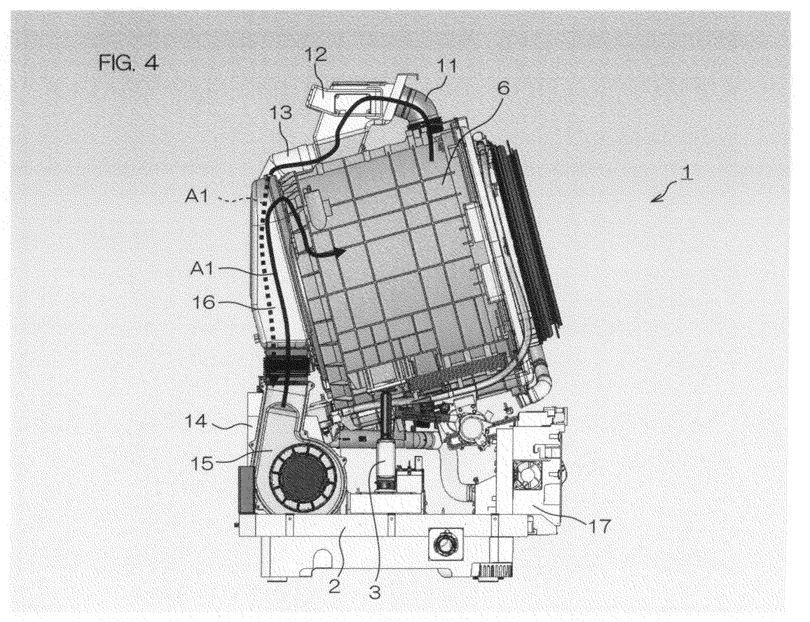

FIG. 1 is a perspective view of a washing/drying machine 1 according to one embodiment of the present invention as seen from a front right upper side with a housing (outer shell) thereof removed. It is noted that some internal components such as a water supply mechanism of the washing/drying machine 1 which are not directly relevant to the present invention are not shown in FIG. 1. FIG. 2 is a perspective view of the washing/drying machine 1 of FIG. 1 as seen from a rear left upper side. FIG. 3 is a right side view of the washing/drying machine 1 shown in FIG. 1, and FIG. 4 is a left side view of the washing/drying machine 1 shown in FIG. 1. FIG. 5 is a rear view of the washing/drying machine 1 shown in FIG. 1.

Referring to FIGS. 1 to 5, the washing/drying machine 1 according to the embodiment of the present invention includes a treatment tub 4 mounted to a base frame 2 via dampers 3. The treatment tub 4 includes an outer tub 6 having a generally cylindrical outer shape as shown in FIG. 1 and having a front port 5 through which garments are loaded into and unloaded from the treatment tub 4, and a rotary drum 7 provided in the outer tub 6.

For washing, the garments are loaded into the rotary drum 7 from the port 5, and a predetermined amount of water is retained in the outer tub 6. Then, the rotary drum 7 is rotated. For dehydration, the water is drained from the outer tub 6, and the rotary drum 7 is rotated at a higher speed.

A DD motor 8 for rotating the rotary drum 7 is fixed to a rear surface of the outer tub 6.

An air circulation duct 10 is connected to an outer portion of the treatment tub 4. When the garments retained in the rotary drum 7 are dried in a drying process, air is circulated from the treatment tub 4 through the air circulation duct 10.

More specifically, the air circulation duct 10 is a concatenation structure which includes an air outlet duct 11 having one end connected to a front portion of an upper surface of the outer tub 6, a lint filter unit 12 connected to the other end of the air outlet duct 11, a downward air duct 13 having an upper end connected to the lint filter unit 12 and extending downward on a rear side of the outer tub 6, a heat pump unit 14 connected to a lower end of the downward air duct 13 and horizontally disposed as extending laterally along a rear edge of the base frame 2, an air blower unit 15 attached to one of opposite ends of the heat pump unit 14, and an air inlet duct 16 having a lower end connected an upper portion of the air blower unit 15 and an upper end connected to an upper portion of the rear surface of the outer tub 6. The air is circulated from the treatment tub 4 through the concatenation structure, i.e., the air circulation duct 10, in an arrow direction A1.

One feature of the washing/drying machine 1 according to this embodiment is that the air circulation duct 10 to be utilized for the drying process, particularly, the heat pump unit 14 and the air blower unit 15 of the air circulation duct 10, is configured in the following unique manner.

Specifically, the heat pump unit 14 has a generally rectangular box-like outer shape, and is disposed laterally along the rear edge of the base frame 2. The air blower unit 15 is fixed to one side surface of the heat pump unit 14. With this arrangement, an empty space present above the base frame 2 can be effectively utilized to accommodate the heat pump unit 14 and the air blower unit 15 on a rear lower side of the treatment tub 6. Further, as will be described later, the air being circulated flows laterally horizontally in the heat pump unit 14, so that highly efficient heat exchange can be achieved in the heat pump unit 14.

Further, the air blower unit 15 is disposed downstream of the heat pump unit 14 with respect to an airflow direction in the air circulation duct 10, so that the air is sucked out of the heat pump unit 14 and the sucked air is fed into the air inlet duct 16. Thus, the air blower unit 15 is of the type adapted to suck the air out of the heat pump unit 14. Therefore, as will be described later, the air can flow through the heat pump unit 14 at a generally uniform flow rate. This improves the heat exchange efficiency.

Other components illustrated in FIGS. 1 to 5 will be briefly described. A control circuit unit 17 is attached to a left side of the base frame 2, and a lint filter unit 18 for removing lint from drained water is provided on a right side of the control circuit unit 17.

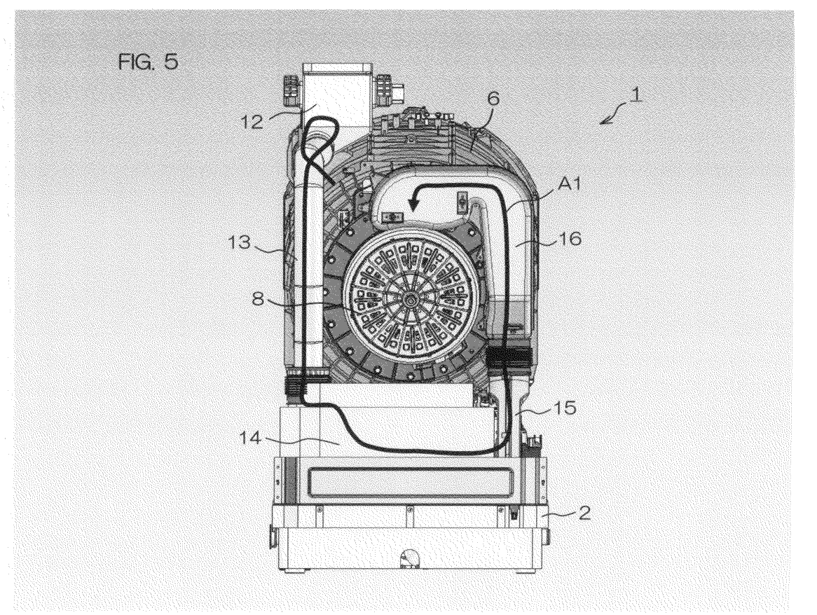

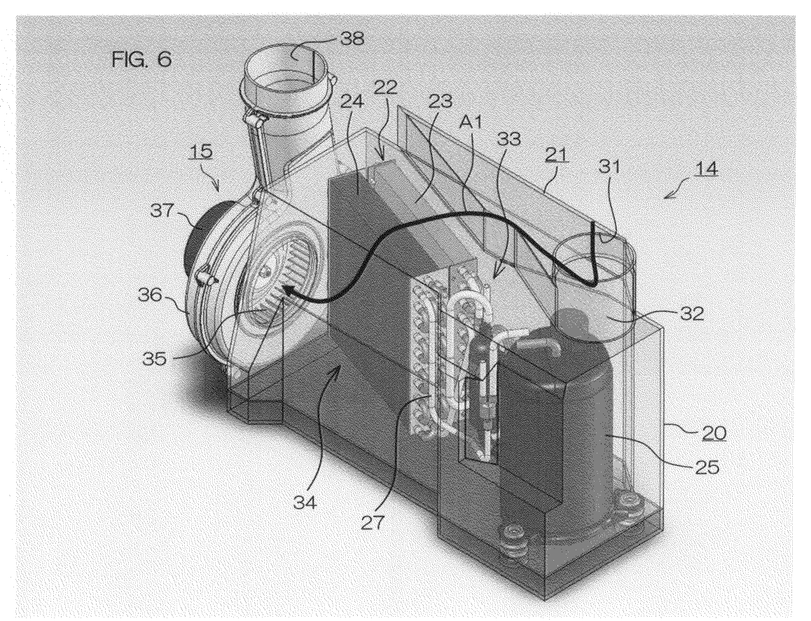

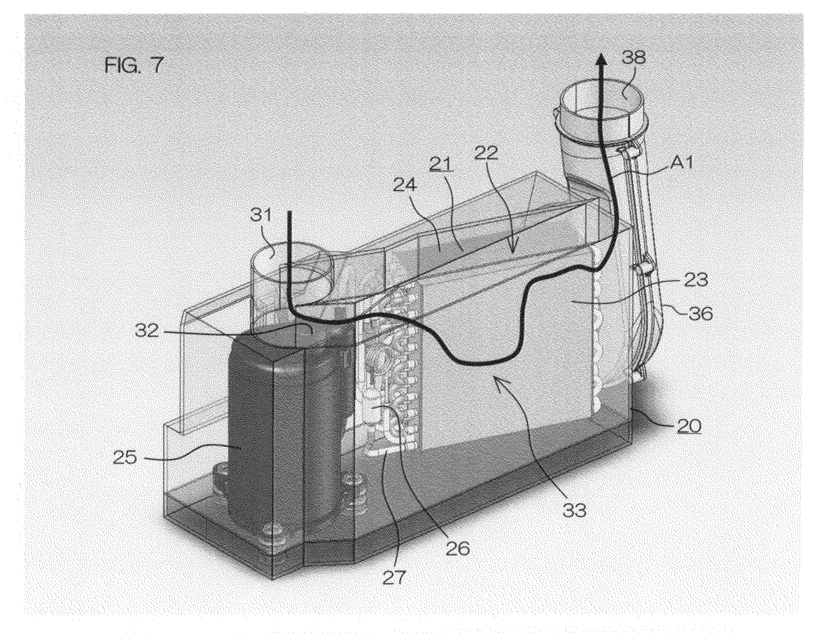

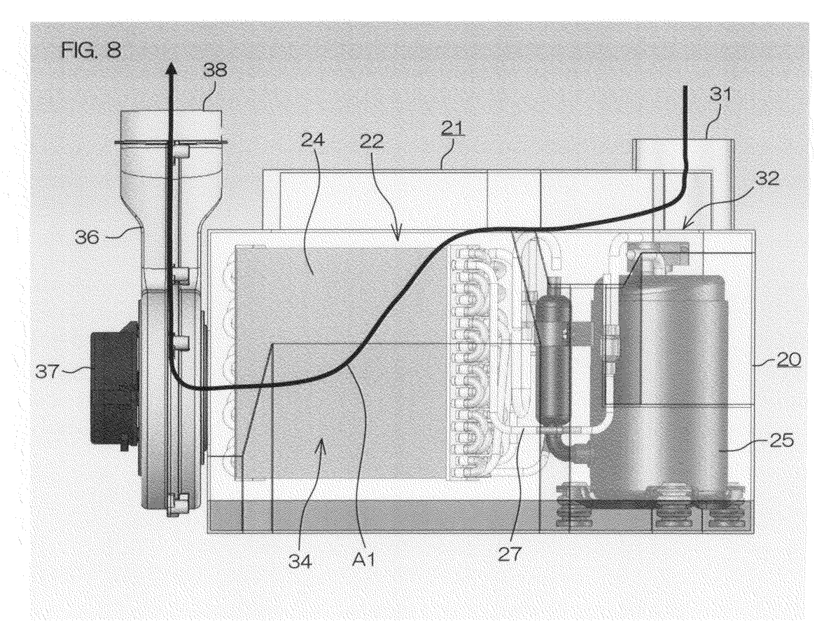

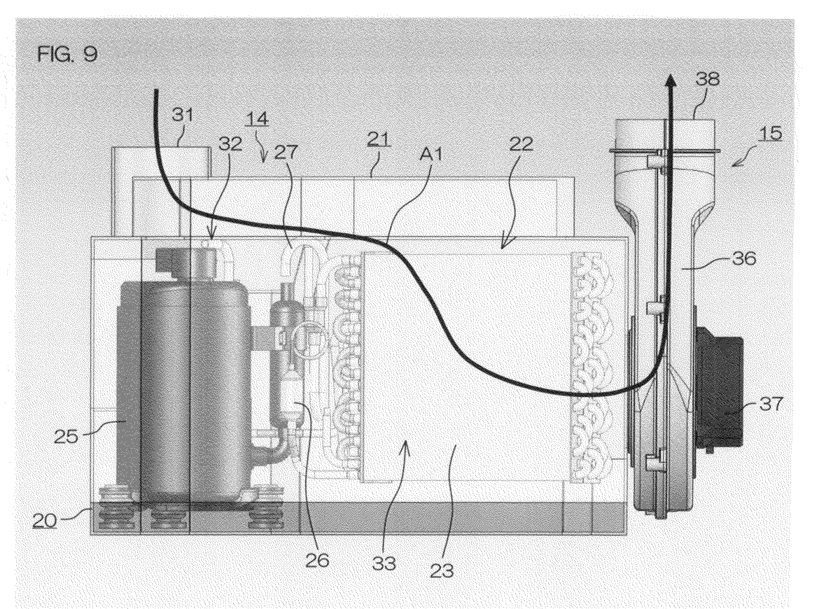

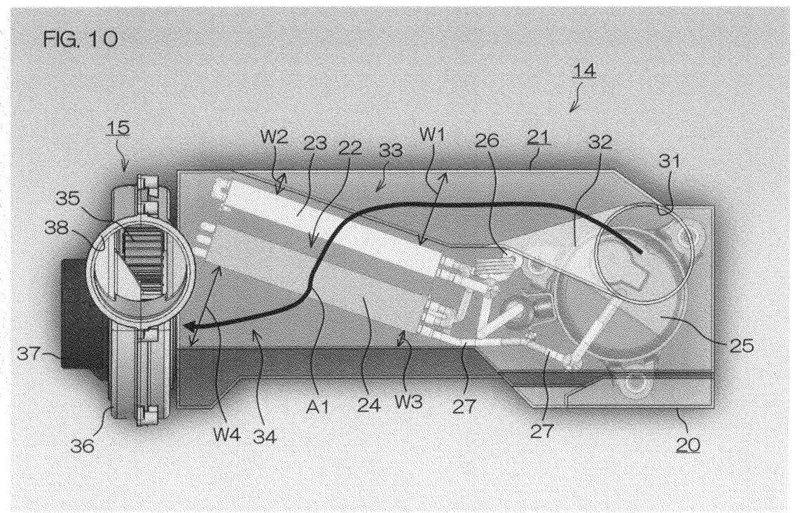

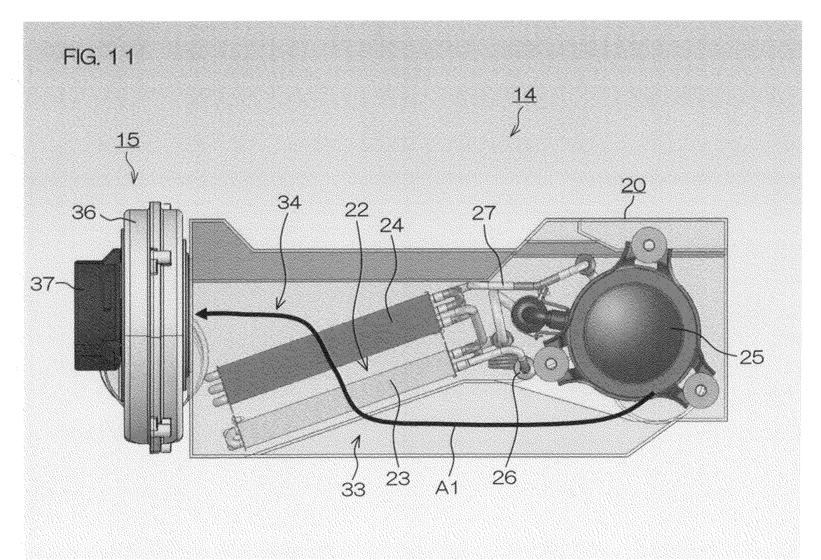

FIGS. 6 to 13 show the constructions of the heat pump unit 14 and the air blower unit 15. FIG. 6 is a perspective view of the heat pump unit 14 and the air blower unit 15 as seen from a front right upper side, and FIG. 7 is a perspective view of the heat pump unit 14 and the air blower unit 15 as seen from a rear right upper side. FIG. 8 is a front view of the heat pump unit 14 and the air blower unit 15, and FIG. 9 is a rear view of the heat pump unit 14 and the air blower unit 15. FIG. 10 is a plan view of the heat pump unit 14 and the air blower unit 15, and FIG. 11 is a bottom view of the heat pump unit 14 and the air blower unit 15. FIG. 12 is a right side view of the heat pump unit 14 and the air blower unit 15, and FIG. 13 is a left side view of the heat pump unit 14 and the air blower unit 15.

In FIGS. 6 to 13, the arrow A1 represents the flow of the air in the heat pump unit 14 and the air blower unit 15.

Referring to FIGS. 6 to 13, the heat pump unit 14 includes a casing 20 having a generally rectangular box shape, and a sub-casing 21 attached to an upper surface of the casing 20 and having a wedge-like plan shape. A heat exchange air duct portion 22 through which the air flows in the arrow direction A1 is defined in the casing 20. A heat absorber 23 and a radiator 24 are provided as a heat exchanger in the heat exchange air duct portion 22. The heat absorber 23 is disposed on an upstream side, and the radiator 24 is disposed on a downstream side with respect to the airflow direction. The heat absorber 23 and the radiator 24 are spaced parallel to each other a predetermined distance with their airflow planes extending vertically. As shown in FIG. 10, the airflow planes of the heat absorber 23 and the radiator 24 are inclined with respect to the airflow direction indicated by the arrow A1 (the airflow direction in the heat exchange air duct portion 22). The airflow planes of the heat absorber 23 and the radiator 24 thus inclined each have a larger airflow plane area.

A compressor 25, an expansion valve 2 (pressure reducing means) and a coolant pipe 27 through which a coolant flows are disposed in a region of the casing 20 which does not hinder the airflow in the heat exchange air duct portion 22, i.e., disposed outside a region defined as the heat exchange air duct portion 22. The heat absorber 23, the compressor 25, the radiator 24 and the expansion valve 26 are connected by the coolant pipe 27 so that the coolant flows through the heat absorber 23, the compressor 25, the radiator 24 and the expansion valve 26 in this order.

The coolant flowing through the coolant pipe 27 repeatedly experiences the following state change. The pressure of the coolant is steeply reduced by the expansion valve 26, whereby the temperature of the coolant is reduced to a lower level. The lower temperature coolant is applied to the heat absorber 23. Therefore, the lower temperature coolant and the air flowing through the heat exchange air duct portion 22 are heat-exchanged by the heat absorber 23, whereby the air is cooled. The coolant having passed through the heat absorber 23 is applied to the compressor 25 through the coolant pipe 27. The coolant is compressed by the compressor 25, whereby the temperature of the coolant is increased to a higher level. The higher temperature coolant is applied to the radiator 24 through the coolant pipe 27. The higher temperature coolant and the air flowing through the heat exchange air duct portion 22 are heat-exchanged by the radiator 24, whereby the air flowing through the heat exchange air duct portion 22 is heated. Then, the coolant flows into the expansion valve 26 through the coolant pipe, whereby the coolant has a reduced pressure and hence has a reduced temperature again.

Next, the configuration of the heat exchange air duct portion 22 will be described. As shown in FIG. 2, the air taken out of the outer tub 6 flows down through the downward air duct 13 and, as shown in FIGS. 6 and 10, flows into the sub-casing 21 from an inlet port 31 of the sub-casing 21. An upper surface portion 32 of the casing 20 is opposed to a lower portion of the inlet port 31, so that the airflow is deflected from a downward direction to a lateral direction by the upper surface portion 32.

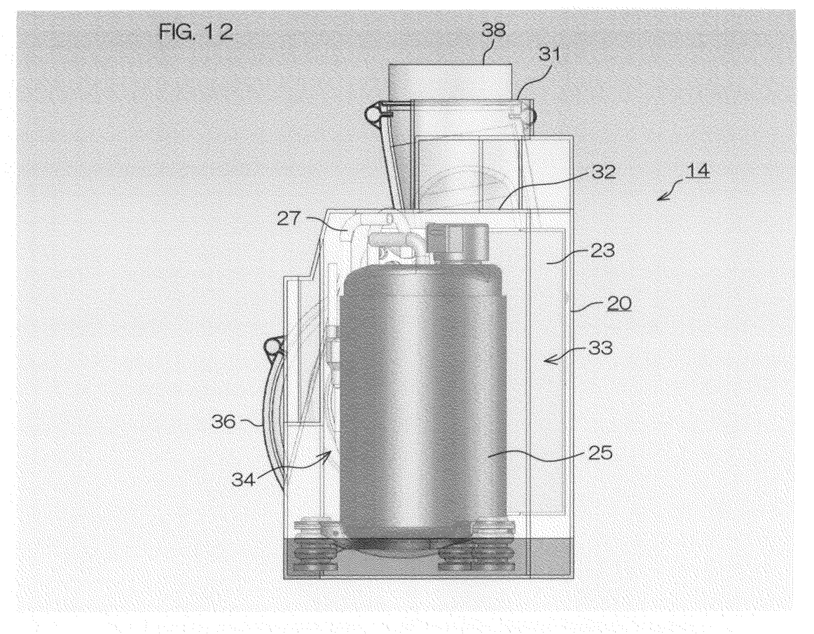

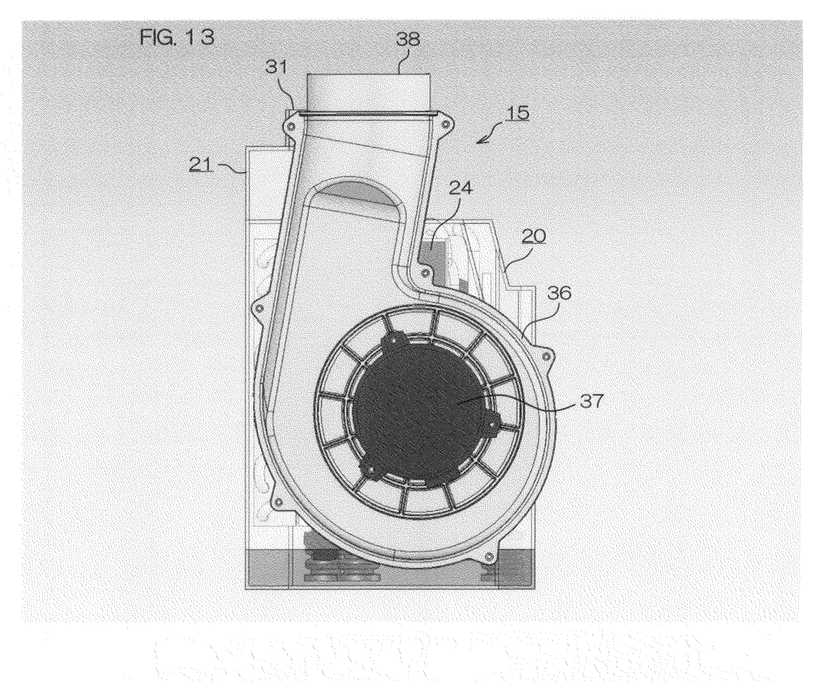

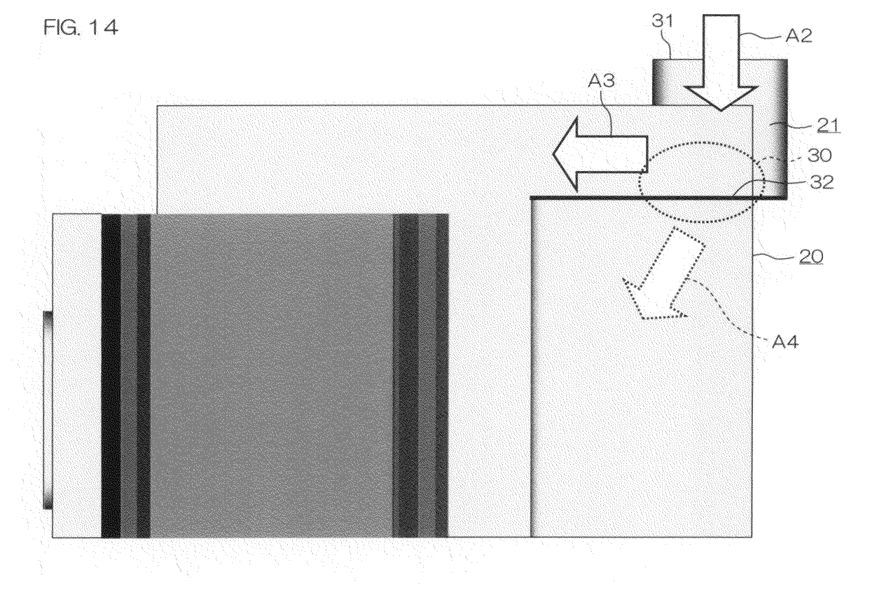

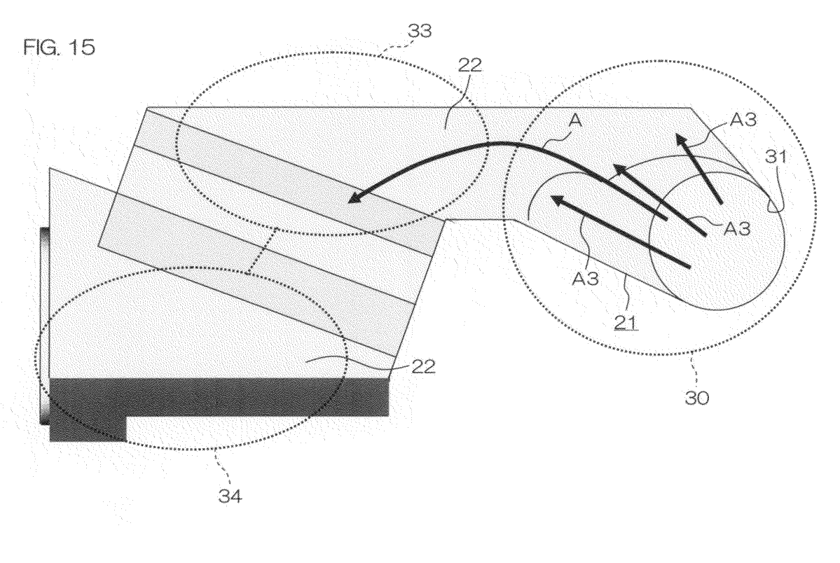

More specific description will be given with reference to FIGS. 14 and 15. FIG. 14 is a schematic front view of the heat pump unit 14 for explaining how the air flows into the heat exchange air duct portion 22. FIG. 15 is a schematic plan view of the heat pump unit 14 for explaining how the air flows into the heat exchange air duct portion 22.

As shown in FIG. 14, the air flowing into the sub-casing 21 from the inlet port 31 impinges on the upper surface portion of the casing 20, whereby the air is distributed. Thus, the airflow is regulated uniformly with respect to the height. That is, the air A2 flowing downward impinges on the upper surface portion 32 of the casing 20 to be distributed as lateral airflow A3. As shown in FIG. 15, the lateral airflow A3 is distributed in the sub-casing 21. Then, the air partly flows to the rear side of the casing 20 (as indicated by A4 in FIG. 14).

The sub-casing 21 is thus provided in an air inlet passage to the casing 20, whereby a buffer space 30 is defined in which the airflow is deflected from the downward direction to the lateral direction around the sub-casing 21 to be regulated uniformly with respect to the height.

Then, the air caused to flow uniformly with respect to the height in the buffer space 30 flows laterally into an upstream buffer space 33 as will be described below. In the upstream buffer space 33, the flow direction and the flow rate of the air is regulated. After the air flows to the heat exchanger, the airflow is regulated more uniformly in a downstream buffer space 34 provided downstream of the heat exchanger.

Where a flow passage through which the air flows into the upstream buffer space 33 from the buffer space 30 is bent in a chevron plan shape as indicated by an arrow A in FIG. 15, the flow passage has an increased length. As a result, the airflow to the heat exchanger can be regulated more uniformly.

As shown in FIG. 10, the upstream buffer space 33 is disposed below the sub-casing 21 to define a part of the heat exchange air duct portion 22 in the casing 20. The upstream buffer space 33 includes a region having a triangular plan shape as shown in FIG. 10. In other words, the triangular upstream buffer space 33 as seen in plan includes a portion having a greater width W1 in opposed relation to one of opposite edges of the airflow plane of the heat absorber 23 disposed in the heat exchange air duct portion 22, and a portion having a smaller width W2 in opposed relation to the other edge of the airflow plane of the heat absorber 23. With the provision of the upstream buffer space 33, the flow direction of the air flowing into the casing 20 from the inlet port 31 of the sub-casing 21 through the sub-casing 21 is regulated, and the flow rate of the air is made uniform. This prevents the air flowing to the heat absorber 23 from having a locally uneven flow rate, making it possible to produce generally uniform airflow.

Next, the downstream buffer space will be described. Referring mainly to FIG. 10, the downstream buffer space 34 is provided downstream of the radiator 24 with respect to the airflow direction in the heat exchange air duct portion 22 defined in the casing 20. The downstream buffer space 34 includes a triangular space as seen in plan. More specifically, the downstream buffer space 34 includes a portion having a smaller width W3 in opposed relation to one of opposite edges of the airflow plane of the radiator 24, and a portion having a greater width W4 in opposed relation to the other edge of the airflow plane of the radiator 24. With the provision of the downstream buffer space 34, the flow rate of the air having passed over the radiator 24 is regulated in the downstream buffer space 34. Thus, the air can flow around the radiator 34 at a uniform flow rate.

From another viewpoint, the heat absorber 23 and the radiator 24 are spaced parallel to each other the predetermined distance, and the portion of the upstream buffer space 33 having the greater width W1 is opposed to the one edge of the airflow plane of the heat absorber 23. On the other hand, the portion of the downstream buffer space 34 having the smaller width W3 is opposed to the one edge of the airflow plane of the radiator 24.

Further, the portion of the upstream buffer space 33 having the smaller width W2 is opposed to the other edge of the airflow plane of the heat absorber 23, and the portion of the downstream buffer space 34 having the greater width W4 is opposed to the other edge of the airflow plane of the radiator 24.

Mainly in consideration of the heat absorber 23 and the radiator 24, the heat exchange air duct portion 22 is designed so that the total space width of the space opposed to the airflow plane of the heat absorber 23 on an inlet side and the space opposed to the airflow plane of the radiator 24 on an outlet side is generally constant over the airflow planes without significant local differences.

That is, the heat exchange air duct portion 22 is designed so that the total volume of the spaces on the inlet side and the outlet side of the heat exchanger (the heat absorber 23 and the radiator 24) is generally constant over the airflow planes with the provision of the upstream buffer space 33 and the downstream buffer space 34 on the upstream side and the downstream side of the heat exchanger (the heat absorber 23 and the radiator 24). Thus, the air can substantially uniformly flow around the heat exchanger (the heat absorber 23 and the radiator 24). As a result, the heat exchange efficiency of the heat exchanger (the heat absorber 23 and the radiator 24) is improved.

In the heat exchange air duct portion 22 defined in the casing 20, the air flows generally horizontally. Therefore, the heat exchange air duct portion 22 is free from uneven airflow. This improves the heat exchange efficiency.

In the embodiment described above, the upstream buffer space 33 and the downstream buffer space 34 each have a triangular space as seen in plan by way of example, but the shapes of the upstream buffer space 33 and the downstream buffer space 34 are not limited to this shape. The upstream buffer space 33 and the downstream buffer space 34 may each have a gradational shape, or may have a shape such as a polygonal shape having a gradational sectional area. Even in this case, the air flows uniformly as in the aforementioned embodiment. This also provides the effects of the invention.

The air blower unit 15 is connected to the one side surface of the heat pump unit 14. More specifically, the air blower unit 15 is connected to the one side of the casing 20 so that the air can be sucked out through the portion of the downstream buffer space 34 having the greater width W4.

The air blower unit 15 includes an annular turbo fan 35, a fan case 36 for guiding air fed by the turbo fan 35, and a fan motor 37 provided outside the fan case 36 for rotating the turbo fan 35. When the turbo fan 35 is rotated by the fan motor 37, the air is sucked from a center portion of the annular turbo fan, and the sucked air is released radially outward. Then, the air is fed into the air inlet duct 16 (see FIG. 2) from an upward outlet port 38 of the fan case 36.

The air blower unit 15 connected to the one side surface of the heat pump unit 14 sucks the air out of the downstream buffer space 34 into the treatment tub 4 as previously described. Since the heat pump unit 14 is configured so that the air is sucked out of the heat exchange air duct portion 22, the air can more uniformly flow over the heat absorber 23 and the radiator 24 as compared with a configuration adapted to squeeze the air into the heat exchange air duct portion 22. With the heat pump unit 14 and the air blower unit 15 according to this embodiment, the upstream buffer space 33 and the downstream buffer space 34 are respectively provided upstream and downstream of the heat absorber 23 and the radiator 34, whereby the air can substantially uniformly flow around the heat absorber 23 and the radiator 24. Further, the air blower unit 15 for causing the air to flow is of the type adapted to suck the air out of the heat exchange air duct portion 22, so that the air can more uniformly flow around the heat absorber 23 and the radiator 24. As a result, the efficiency of the heat exchange by the heat absorber 23 and the radiator 24 can be improved.

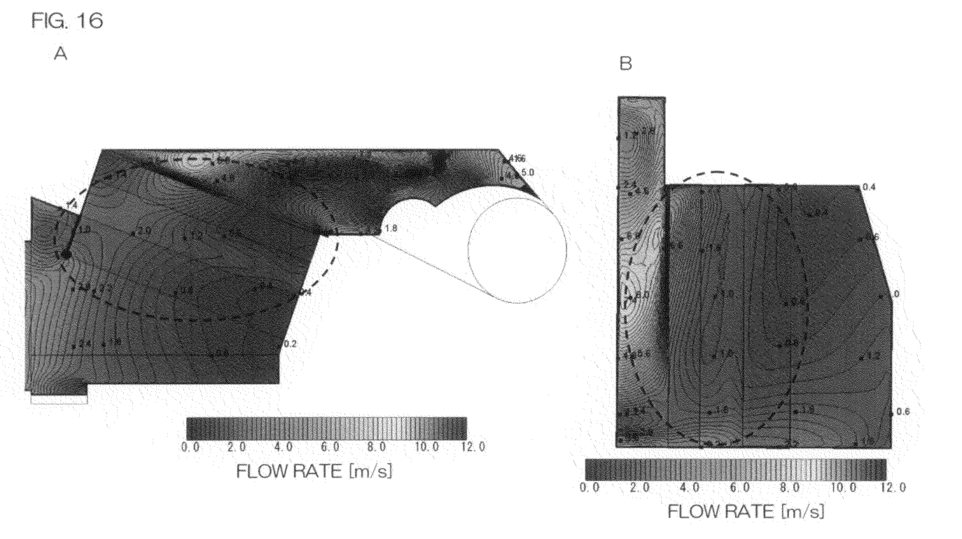

FIGS. 16A and 16B are diagrams of data which verify the uniformity of the flow rate of the air flowing through the heat exchange air duct portion 22 of the heat pump unit 14. FIG. 16A shows a flow rate distribution in a cross section of the heat exchange air duct portion 22, and FIG. 16B shows a flow rate distribution in a vertical section of the heat exchange air duct portion 22. FIGS. 16A and 16B indicate that the air highly uniformly flows at a substantially constant flow rate around the heat absorber 23 and the radiator 24.

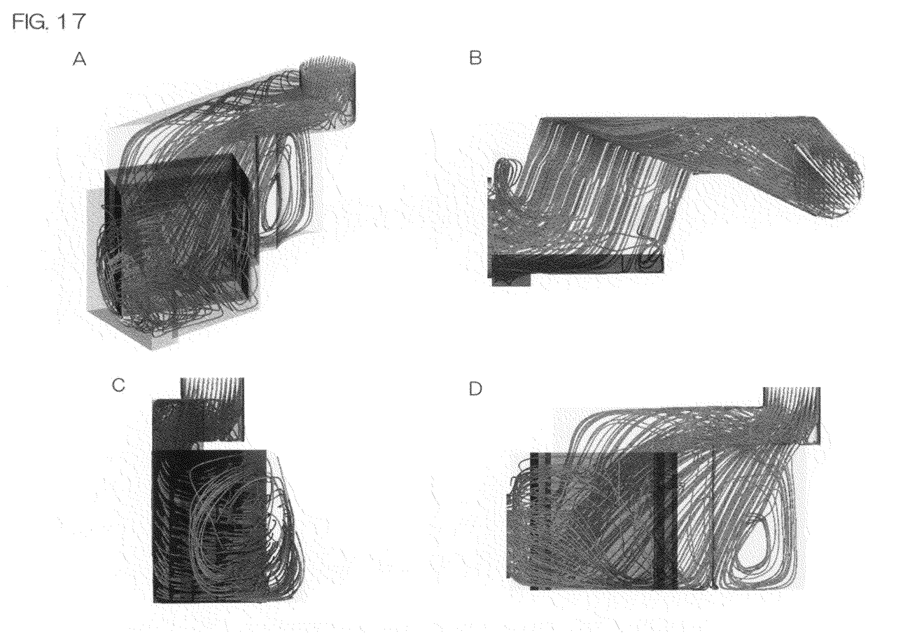

FIGS. 17A to 17D are diagrams obtained through computer-assisted analysis of the flow of the air flowing through the heat exchange air duct portion 22 of the heat pump unit 14 with the airflow indicated by a multiplicity of lines. FIG. 17A is a perspective view showing the airflow in the heat pump unit 14 as seen from a front left upper side, and FIG. 17B is a plan view showing the airflow in the heat pump unit 14. FIG. 17C is a left side view showing the airflow in the heat pump unit 14, and FIG. 17D is a front view showing the airflow in the heat pump unit 14. FIGS. 17A to 17D also indicate that the air substantially uniformly flows through the heat exchange air duct portion 22 in the heat pump unit 4 according to this embodiment.

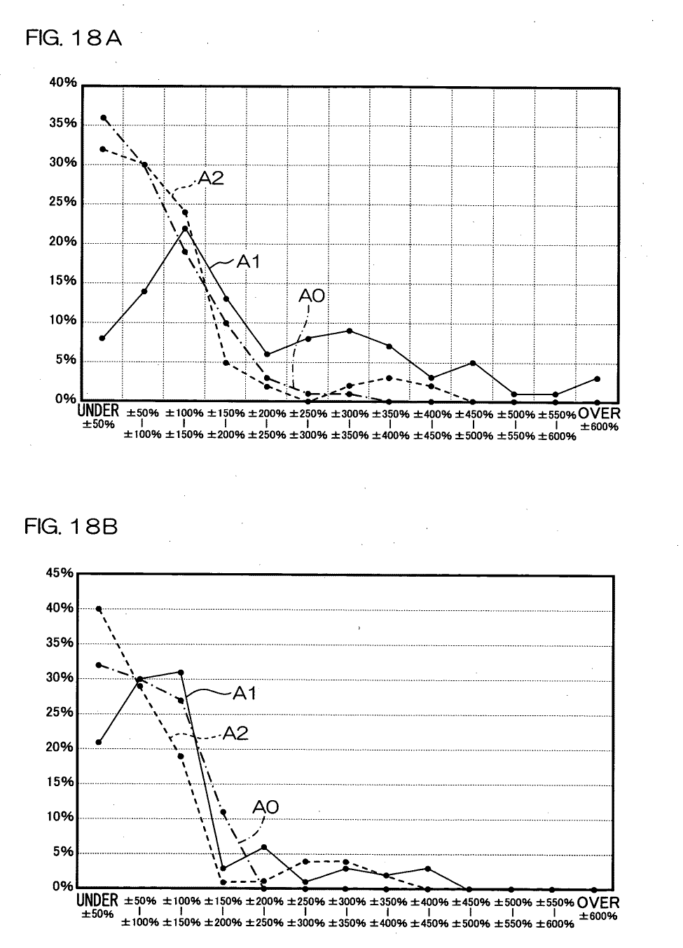

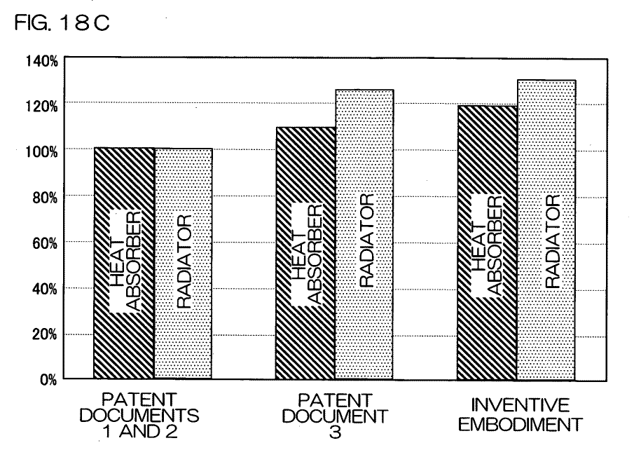

FIGS. 18A to 18C are graphs showing the uniformities of airflow distributions of the air flowing to the heat absorber 23 and the radiator 24 of the heat pump unit 14 in comparison with the constructions described in Patent Document 1, Patent Document 2 and Patent Document 3.

FIG. 18A is a graph showing the airflow distributions A0, A1 and A2 of the air flowing to the heat absorbers in the constructions of the embodiment of the present invention, Patent Documents 1 and 2, and Patent Document 3.

The comparative graph indicates that the uniformity of the airflow distribution A0 of the air flowing to the heat absorber 23 according to this embodiment is improved over the prior arts.

FIG. 18B is a graph showing the airflow distributions A0, A1 and A2 of the air flowing to the radiators in the constructions of the embodiment of the present invention, Patent Documents 1 and 2, and Patent Document 3.

FIG. 18B indicates that the uniformity of the airflow distribution A0 of the air flowing to the radiator 24 according to the embodiment of the present invention is improved over the prior arts.

FIG. 18C shows a comparison of standard deviations determined when the airflow distributions of the air flowing to the heat absorber and the radiator described in Patent Documents 1 and 2 are defined as 100%. This graph also indicates that the air uniformly flows around the heat absorber 23 and the radiator 24 in the embodiment of the present invention.

In the embodiment described above, the expansion valve 26 is provided as the pressure reducing means in the heat pump unit 14. The pressure reducing means is not limited to the expansion valve, but may be, for example, a capillary tube.

In the embodiment described above, the heat pump unit 14 and the air blower unit 15 are provided as a part of a dryer functional section (air circulation duct) in the washing/drying machine 1 by way of example. The present invention is applicable not only to the washing/drying machine 1 but also to a standalone garment dryer.

The heat pump unit has a generally rectangular box shape, which is universal and permits easy incorporation thereof in an electric washing machine, a washing/drying machine, a garment dryer and the like. Therefore, the heat pump unit can be incorporated in a drying functional section of any of various types of dryers.

Examples of the coolant for the heat pump include HFCs (hydrofluorocarbons) and CO₂. Where CO₂ is employed as the coolant in the present invention, CO₂ may be used in a supercritical state.

The present invention is not limited to the embodiment described above, but various modifications may be made within the scope of the appended claims.

1. A garment dryer comprising:
a treatment tub in which a garment to be dried is retained;
an air circulation duct having opposite ends connected to the treatment tub for causing air to flow out of the treatment tub through one of the opposite ends and flow back into the treatment tub through the other end;
air blowing means for circulating the air through the air circulation duct; and
a heat pump device including a heat absorber, a compressor, a radiator and pressure reducing means which are connected by a coolant pipe through which a coolant flows, the heat absorber being adapted to cool the air flowing through the air circulation duct to dehumidify the air, the radiator being adapted to heat the dehumidified air; wherein
the heat absorber and the radiator each have an airflow plane for heat exchange with the air, and the airflow plane of the heat absorber and the airflow plane of the radiator are disposed in this order with respect to an airflow direction in opposed relation in the air circulation duct; and
the air circulation duct includes an upstream buffer space provided upstream of the airflow plane of the heat absorber with respect to the airflow direction for changing a flow direction of the air to regulate a flow rate of the air.

2. The garment dryer according to claim 1, wherein the air circulation duct includes a downstream buffer space provided downstream of the airflow plane of the radiator with respect to the airflow direction for uniformly regulating a flow rate of the air.

3. The garment dryer according to claim 2, wherein the air blowing means is disposed downstream of the downstream buffer space with respect to the airflow direction.

4. A garment dryer comprising:
a treatment tub in which a garment to be dried is retained;
an air circulation duct having opposite ends connected to the treatment tub for causing air to flow out of the treatment tub through one of the opposite ends and flow back into the treatment tub through the other end;
air blowing means for circulating the air through the air circulation duct; and
a heat pump device including a heat absorber, a compressor, a radiator and pressure reducing means which are connected by a coolant pipe through which a coolant flows, the heat absorber being adapted to cool the air flowing through the air circulation duct to dehumidify the air, the radiator being adapted to heat the dehumidified air; wherein
the air circulation duct includes a heat exchange air duct portion in which the heat absorber and the radiator are incorporated;
the heat exchange air duct portion has an airflow direction extending generally horizontally; and
the heat absorber and the radiator each have an airflow plane disposed in the heat exchange air duct portion as inclined with respect to the airflow direction as seen in plan.

5. The garment dryer according to claim 4, wherein the heat exchange air duct portion includes an upstream buffer space provided upstream of the heat absorber.

6. The garment dryer according to claim 5, wherein the heat exchange air duct portion includes a downstream buffer space provided downstream of the radiator for uniformly regulating a flow rate of the air.

7. The garment dryer according to claim 5, wherein the air blowing means is provided horizontally downstream of the downstream buffer space

8. The garment dryer according to claim 6, wherein the air circulation duct includes an air duct portion through which the air flows into the upstream buffer space from a horizontal upper portion of the upstream buffer space.

9. A heat pump unit for the garment dryer according to claim 8, the heat exchange air duct portion being unitized by a casing having a generally rectangular box shape, the heat pump unit comprising:
a heat exchange air duct defined in the casing and having an airflow direction extending generally horizontally; and
a compressor and pressure reducing means provided outside the heat exchange air duct.

10. The garment dryer according to claim 1, wherein the air blowing means is disposed downstream of the downstream buffer space with respect to the airflow direction.

11. The garment dryer according to claim 4, wherein the heat exchange air duct portion includes a downstream buffer space provided downstream of the radiator for uniformly regulating a flow rate of the air.

12. A heat pump unit for the garment dryer according to claim 11, the heat exchange air duct portion being unitized by a casing having a generally rectangular box shape, the heat pump unit comprising:
a heat exchange air duct defined in the casing and having an airflow direction extending generally horizontally; and
a compressor and pressure reducing means provided outside the heat exchange air duct.

13. A heat pump unit for the garment dryer according to claim 7, the heat exchange air duct portion being unitized by a casing having a generally rectangular box shape, the heat pump unit comprising:
a heat exchange air duct defined in the casing and having an airflow direction extending generally horizontally; and
a compressor and pressure reducing means provided outside the heat exchange air duct.

14. A heat pump unit for the garment dryer according to claim 6, the heat exchange air duct portion being unitized by a casing having a generally rectangular box shape, the heat pump unit comprising:
a heat exchange air duct defined in the casing and having an airflow direction extending generally horizontally; and
a compressor and pressure reducing means provided outside the heat exchange air duct.

15. A heat pump unit for the garment dryer according to claim 5, the heat exchange air duct portion being unitized by a casing having a generally rectangular box shape, the heat pump unit comprising:
a heat exchange air duct defined in the casing and having an airflow direction extending generally horizontally; and
a compressor and pressure reducing means provided outside the heat exchange air duct.

16. A heat pump unit for the garment dryer according to claim 4, the heat exchange air duct portion being unitized by a casing having a generally rectangular box shape, the heat pump unit comprising:
a heat exchange air duct defined in the casing and having an airflow direction extending generally horizontally; and
a compressor and pressure reducing means provided outside the heat exchange air duct.
